(19) United States
(12) Patent Application Publication
(10) Pub. No.: US 2016/0293086 A1
(43) Pub. Date: Oct. 6, 2016

(54) COLOR REPRODUCTION SYSTEM AND COLOR REPRODUCTION METHOD

(71) Applicant: SHARP KABUSSHIKI KAISHA, Osaka (JP)

(72) Inventors: Xiaomang ZHANG, Osaka (JP); Hideki MORII, Osaka (JP); Masami OZAKI, Osaka (JP)

(73) Assignee: Sharp Kabushiki Kaisha, Osaka (JP)

(21) Appl. No.: 15/035,567

(22) PCT Filed: Jul. 22, 2014
(86) PCT No.: PCT/JP2014/069301

§ 371 Date: May 10, 2016

(30) Foreign Application Priority Data
Nov. 12, 2013 (JP) 2013-233730

(51) Int. Cl. G09G 3/20; G09G 3/36

(52) U.S. Cl. CPC G09G 3/2003; G09G 3/36; G09G 2320/0242; G09G 2320/0276; G09G 2340/06

(57) ABSTRACT

Provided is a color reproduction system that prevents differences in display image coloring due to a primary device and can also be produced more easily than when using conventional technologies. The color reproduction system includes: an electronic device that includes an input data converter that performs a color gamut conversion process to input data (DIN) in accordance with the color gamut of the input data (DIN) and a color gamut specified by a prescribed standard (such as sRGB or bg-sRGB); and a liquid crystal display device that includes an image data converter and a liquid crystal panel. The image data converter performs a color gamut conversion process on image data (DAT) sent from the electronic device in accordance with the color gamut specified by the prescribed standard and the color gamut of the liquid crystal panel, and the liquid crystal panel displays an image using the image data (DAT). In this configuration, only an RGB signal compliant with the prescribed standard is sent from the electronic device to the liquid crystal display device.

### TECHNICAL FIELD

The present invention relates to a color reproduction system, and more particularly to a color reproduction system that includes a liquid crystal display device and a primary device thereof.

### BACKGROUND ART

Typically, devices such as display devices, printing devices, and imaging devices each have a different color gamut (also known as color reproduction range). Moreover, in color televisions, the color gamut utilized in input video signals is different for every television standard. For these reasons, conventionally the color gamut of the signal from the signal source is mapped to the color gamut of the display device. Furthermore, in a liquid crystal display device, for example, voltages are applied to the liquid crystal layer according to the color values included in the RGB signal resulting from the mapping process so that the colors displayed on the display unit represent the colors in the signal from the signal source as accurately as possible. This mapping process, which is performed so that the output colors are as faithful as possible to colors in the input data regardless of differences in the color gamuts involved, is known as color gamut conversion. RGB signals with the same RGB values may actually produce different colors on display devices with different color gamuts, and therefore this color gamut conversion process adjusts the values of the RGB signals accordingly.

FIG. 17 is a block diagram schematically illustrating a configuration of a conventional color reproduction system that includes a liquid crystal display device and performs the color gamut conversion process described above. As illustrated in FIG. 17, this color reproduction system 90 includes a liquid crystal display device 92 and an electronic device 91 (a primary device of the liquid crystal display device 92). The liquid crystal display device 92 stores display information such as chromaticity coordinates of the three primary colors and gamma parameters. The electronic device 91 loads the display information stored in the liquid crystal display device 92 and performs a color gamut conversion process on input data according to that display information. An RGB signal obtained from the color gamut conversion process is sent from the electronic device 91 to the liquid crystal display device 92, and the liquid crystal display device 92 displays the resulting image. In this way, the colors in the image displayed on the display unit of the liquid crystal display device 92 are as faithful as possible to the colors in the input data regardless of differences between the color gamut of the input data and the color gamut of the liquid crystal display device 92.

WO 2011/061954 Pamphlet, for example, discloses one example of such a color gamut conversion process. WO 2011/061954 Pamphlet discloses a display device that includes an image processing device (which corresponds to the electronic device 91 in FIG. 17) and a liquid crystal panel (which corresponds to the liquid crystal display device 92 in FIG. 17). As illustrated in FIG. 18, in this display device the image processing device performs a color gamut conversion process to generate an RGB signal for the liquid crystal panel, and the liquid crystal panel displays an image using that RGB signal.

### RELATED ART DOCUMENT

### Patent Document

Patent Document 1: WO 2011/061954 Pamphlet

### SUMMARY OF THE INVENTION

### Problems to be Solved by the Invention

However, different electronic device manufacturers employ different levels of technology. Moreover, some manufacturers develop different color specifications in pursuit of unique colors. Therefore, even the same liquid crystal display device may exhibit different display image coloring depending on the electronic devices that are connected thereto. In other words, even when the same data is displayed on the same liquid crystal display device, the colors or color tones of the resulting display image may be different due to the differences between these electronic devices. Furthermore, these electronic devices have to perform the color gamut conversion process using the display information from the liquid crystal display device, which increases the development burden on electronic device manufacturers.

Therefore, the present invention aims to provide a color reproduction system that prevents differences in display image coloring due to the primary device and can also be produced more easily than when using conventional technologies.

### Means for Solving the Problems

A first aspect of the present invention is a color reproduction system, including:

a primary device that performs a color gamut conversion process on input data so as to output image data; and a liquid crystal display device having a liquid crystal panel, the liquid crystal display device displaying on the liquid crystal panel a color image based on the image data output from the primary device,

wherein a color gamut of the liquid crystal panel includes a color gamut specified by a prescribed standard, and

wherein the primary device sends to the liquid crystal display device as the image data only an RGB signal compliant with the prescribed standard.

A second aspect of the present invention is the color reproduction system according to the first aspect, wherein the prescribed standard is an sRGB standard.

A third aspect of the present invention is the color reproduction system according to the first aspect, wherein the prescribed standard is an bg-sRGB standard.

A fourth aspect of the present invention is the color reproduction system according to the third aspect, wherein the color gamut of the liquid crystal panel includes a color gamut of the input data.

A fifth aspect of the present invention is the color reproduction system according to the third aspect, wherein when a minimum gradation value is 0 and a maximum gradation value is 1, the RGB signal sent from the primary device to the liquid crystal display device can include values that are negative or greater than 1.

A sixth aspect of the present invention is the color reproduction system according to the third aspect, wherein the image data sent from the primary device to the liquid crystal display device is 10-bit data.

A seventh aspect of the present invention is the color reproduction system according to the first aspect,

wherein the primary device includes an input data converter that generates the image data by performing, in accordance with a color gamut of the input data and the color gamut specified by the prescribed standard, a color gamut conversion process on the input data, and

wherein the liquid crystal display device includes an image data converter that generates display data for the liquid crystal panel by performing, in accordance with the color gamut specified by the prescribed standard and the color gamut of the liquid crystal panel, a color gamut conversion process on the image data sent from the primary device.

An eighth aspect of the present invention is the color reproduction system according to the first aspect,

wherein the primary device includes an input data converter that generates the image data by performing, in accordance with a color gamut of the input data and the color gamut specified by the prescribed standard, a color gamut conversion process on the input data, and

wherein the liquid crystal display device includes:
an image data converter that generates display data for the liquid crystal panel by performing, in accordance with the color gamut specified by the prescribed standard and the color gamut of the liquid crystal panel, a color gamut conversion process on the image data sent from the primary device; and
a display data gamma correction processor that performs a gamma correction process on the display data generated by the image data converter.

A ninth aspect of the present invention is the color reproduction system according to the first aspect,

wherein the primary device includes:
an input data converter that generates the image data by performing, in accordance with a color gamut of the input data and the color gamut specified by the prescribed standard, a color gamut conversion process on the input data; and
an image data gamma correction processor that performs a gamma correction process on the image data generated by the input data converter, and

wherein the liquid crystal display device includes:
a de-gamma correction processor that performs a de-gamma correction process on the image data sent from the primary device;
an image data converter that generates display data for the liquid crystal panel by performing, in accordance with the color gamut specified by the prescribed standard and the color gamut of the liquid crystal panel, a color gamut conversion process on the image data on which the de-gamma correction processor performed the de-gamma correction process; and
a display data gamma correction processor that performs a gamma correction process on the display data generated by the image data converter.

A tenth aspect of the present invention is the color reproduction system according to the first aspect,
wherein the primary device includes:
   an input data converter that generates the image data by performing, in accordance with a color gamut of the input data and the color gamut specified by the prescribed standard, a color gamut conversion process on the input data; and
   an image data gamma correction processor that performs a gamma correction process on the image data generated by the input data converter,
wherein the color gamut of the liquid crystal panel matches the color gamut specified by the prescribed standard, and
wherein the liquid crystal display device displays on the liquid crystal panel a color image based on the image data sent from the primary device without first performing a color gamut conversion process thereon.

An eleventh aspect of the present invention is the color reproduction system according to the first aspect, wherein the color gamut of the liquid crystal panel includes a color gamut of the input data.

A twelfth aspect of the present invention is a color reproduction method for a color reproduction system that includes a primary device that outputs image data in accordance with input data and a liquid crystal display device that includes a liquid crystal panel that has a color gamut including a color gamut specified by a prescribed standard and that displays a color image based on the image data output from the primary device, the color reproduction method including:

a generating step in which the image data is generated by performing a color gamut conversion process on the input data by the primary device; and

a sending step in which the image data is sent from the primary device to the liquid crystal display device,

wherein, in the sending step, only an RGB signal compliant with the prescribed standard is sent from the primary device to the liquid crystal display device as the image data.

A thirteenth aspect of the present invention is a color reproduction system, including:

a primary device that outputs image data obtained by performing a color gamut conversion process on input data; and a liquid crystal display device having a liquid crystal panel, the liquid crystal display device displaying on the liquid crystal panel a color image based on the image data output from the primary device,

wherein a plurality of operation modes are prepared so as to be selectable,

wherein a color gamut of the liquid crystal panel includes a color gamut specified by a prescribed standard, and

wherein, when a prescribed operation mode among the plurality of operation modes is selected, the primary device sends to the liquid crystal display device as the image data only an RGB signal compliant with the prescribed standard.

A fourteenth aspect of the present invention is a color reproduction method for a color reproduction system that includes a primary device that outputs image data in accordance with input data and a liquid crystal display device that includes a liquid crystal panel that has a color gamut including a color gamut specified by a prescribed standard and that displays a color image based on the image data output from the primary device, the color reproduction method including:

a generating step in which the image data is generated by performing a color gamut conversion process on the input data by the primary device; and

a sending step in which the image data is sent from the primary device to the liquid crystal display device,

wherein a plurality of operation modes are prepared so as to be selectable, and

wherein, when a prescribed operation mode among the plurality of operation modes is selected, in the sending step only an RGB signal compliant with the prescribed standard is sent from the primary device to the liquid crystal display device as the image data.

### Effects of the Invention

In the first aspect of the present invention, the color reproduction system is configured such that only an RGB signal compliant with the prescribed standard is sent from the primary device to the liquid crystal display device. Therefore, the primary device may implement any data conversion process for converting the input data to data that is compliant with the prescribed standard regardless of the color gamut of the liquid crystal panel. Moreover, the liquid crystal display device may implement any data conversion process appropriate for the color gamut of the liquid crystal panel. Therefore, the primary device can implement the necessary process without requiring any information from the liquid crystal display device, and the liquid crystal display device can implement the necessary process without requiring any information from the primary device. This makes it possible to design and manufacture the primary device and the liquid crystal display device completely independently of one another. This, in turn, reduces the burden associated with color reproduction on manufacturers. Moreover, the implementations of the processes can be defined in advance, thereby making it unnecessary to determine various parameters using an online process. This makes it possible to produce color reproduction systems more easily than when using conventional technologies and reduces the costs of producing color reproduction systems. Furthermore, the image data sent to the liquid crystal display device is based on a predefined standard that does not depend on the primary device connected thereto, thereby preventing variation in the colors represented by that image data. This prevents differences in display image coloring due to the primary device. Therefore, the first aspect of the present invention makes it possible to provide a color reproduction system that prevents differences in display image coloring due to the primary device and can also be produced more easily than when using conventional technologies.

In the second aspect of the present invention, sRGB image data is sent from the primary device to the liquid crystal display device. As a result, colors in the standard sRGB color space are displayed accurately on the liquid crystal panel of the liquid crystal display device.

In the third aspect of the present invention, bg-sRGB image data is sent from the primary device to the liquid crystal display device. This makes it possible to accurately display colors of a larger gamut than that of the standard sRGB color space.

In the fourth aspect of the present invention, the color gamut of the liquid crystal panel is larger than the color gamut of the input data, and bg-sRGB image data is sent from the primary device to the liquid crystal display device. As a result, all of the colors represented in the input data can be displayed accurately on the liquid crystal panel of the liquid crystal display device.

In the fifth aspect of the present invention, image data that includes RGB values that are negative or greater than 1 is sent from the primary device to the liquid crystal display device. As a result, image data that represents colors of a larger gamut than that of the standard sRGB color space are sent from the primary device to the liquid crystal display device. This makes it possible to reproduce a colors of a larger gamut than that of the standard sRGB color space on the liquid crystal panel (as long as those colors are not outside of the color gamut of the liquid crystal panel itself).

In the sixth aspect of the present invention, the color reproduction system is configured such that 10-bit data is sent from the primary device to the liquid crystal display device, thereby achieving the same effects as in the fifth aspect of the present invention.

In the seventh aspect of the present invention, the primary device may implement any color gamut conversion process for converting the input data to data that is compliant with the prescribed standard regardless of the color gamut of the liquid crystal panel. Moreover, the liquid crystal display device may implement any color gamut conversion process appropriate for the color gamut of the liquid crystal panel. Therefore, like the first aspect of the present invention, the seventh aspect of the present invention makes it possible to provide a color reproduction system that prevents differences in display image coloring due to the primary device and can also be produced more easily than when using conventional technologies.

In the eighth aspect of the present invention, after the image data converter of the liquid crystal display device generates the display data for the liquid crystal panel, a gamma correction process is applied performed on that display data. Therefore, even when the liquid crystal panel exhibits a non-linear relationship between the gradation values in the input signal (the display data) input thereto and the resulting display brightness, the colors represented in the input data input to the primary device can still be reproduced accurately on the liquid crystal panel.

In the ninth aspect of the present invention, the color reproduction system is configured such that gamma-corrected image data is sent from the primary device to the liquid crystal display device, thereby achieving the same effects as in the eighth aspect of the present invention.

In the tenth aspect of the present invention, gamma-corrected image data compliant with the prescribed standard is sent from the primary device to the liquid crystal display device, and in the liquid crystal display device, the image data that is compliant with the prescribed standard and was sent from the primary device is input as-is to the liquid crystal panel. Therefore, the tenth aspect of the present invention makes it possible to use a relatively simple configuration to prevent differences in display image coloring due to the primary device in cases in which a general-purpose display with a standard color gamut is used.

In the eleventh aspect of the present invention, colors represented within the color gamut of the prescribed standard in the input data are displayed accurately on the liquid crystal panel.

The twelfth aspect of the present invention makes it possible to provide a color reproduction method for a color reproduction system that achieves the same effects as in the first aspect of the present invention.

In the thirteenth aspect of the present invention, a plurality of operation modes are prepared in advance for the color reproduction system, and when a prescribed operation mode is selected, differences in display image coloring due to the primary device are prevented.

The fourteenth aspect of the present invention makes it possible to provide a color reproduction method for a color reproduction system that achieves the same effects as in thirteenth aspect of the present invention.

### BRIEF DESCRIPTION OF THE DRAWINGS

FIG. 1 is a block diagram illustrating an overall configuration of a liquid crystal display device according to Embodiment 1 of the present invention.

FIG. 2 is a table showing the chromaticity coordinates of the primary colors and a white point in Embodiment 1 in several common standard color spaces.

FIG. 3 is an xy chromaticity diagram for Embodiment 1 showing the color gamuts of several common standard color spaces.

FIG. 4 shows part of the matrix notation used in Embodiment 1.

FIG. 5 shows another part of the matrix notation used in Embodiment 1.

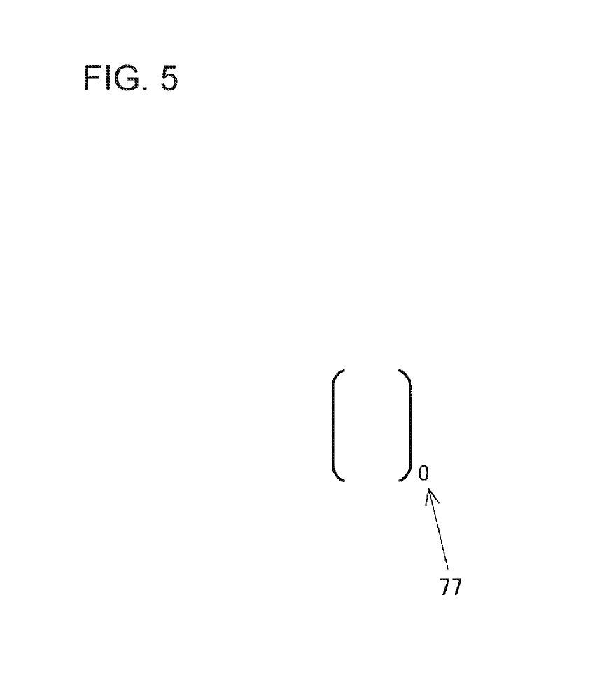

FIG. 6 illustrates a color gamut converter of Embodiment 1.

FIG. 7 illustrates a process implemented in an electronic device of Embodiment 1.

FIG. 8 illustrates a process implemented in the liquid crystal display device of Embodiment 1.

FIG. 9 is a block diagram illustrating an overall configuration of a liquid crystal display device according to Embodiment 2 of the present invention.

FIG. 10 is a block diagram illustrating an overall configuration of a liquid crystal display device according to Embodiment 3 of the present invention.

FIG. 11 illustrates a process implemented in a liquid crystal display device of Embodiment 3.

FIG. 12 is a block diagram illustrating an overall configuration of a liquid crystal display device according to Embodiment 4 of the present invention.

FIG. 13 illustrates a process implemented in an electronic device of Embodiment 4.

FIG. 14 illustrates a process implemented in a liquid crystal display device of Embodiment 4.

FIG. 15 is a block diagram illustrating an overall configuration of a liquid crystal display device according to Embodiment 5 of the present invention.

FIG. 16 illustrates a process implemented in a liquid crystal display device of Embodiment 5.

FIG. 17 is a block diagram schematically illustrating a configuration of a conventional color reproduction system that includes a liquid crystal display device and performs a color gamut conversion process.

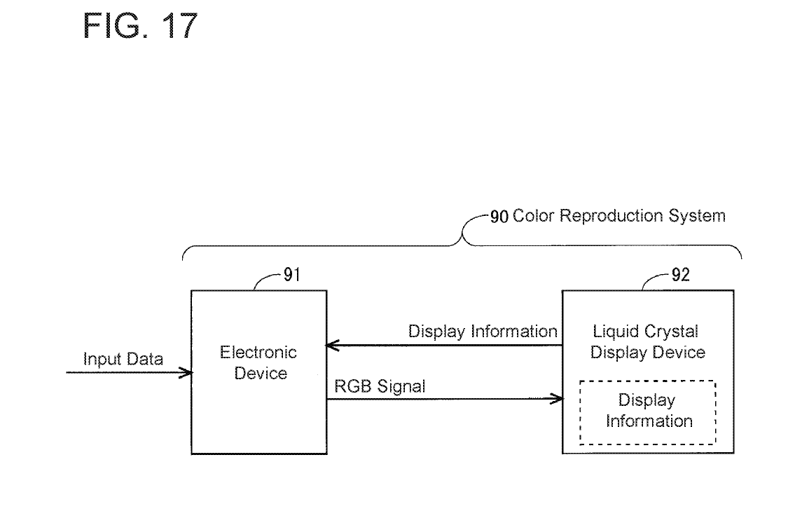

FIG. 18 is a block diagram illustrating a configuration of the display device disclosed in WO 2011/061954 Pamphlet.

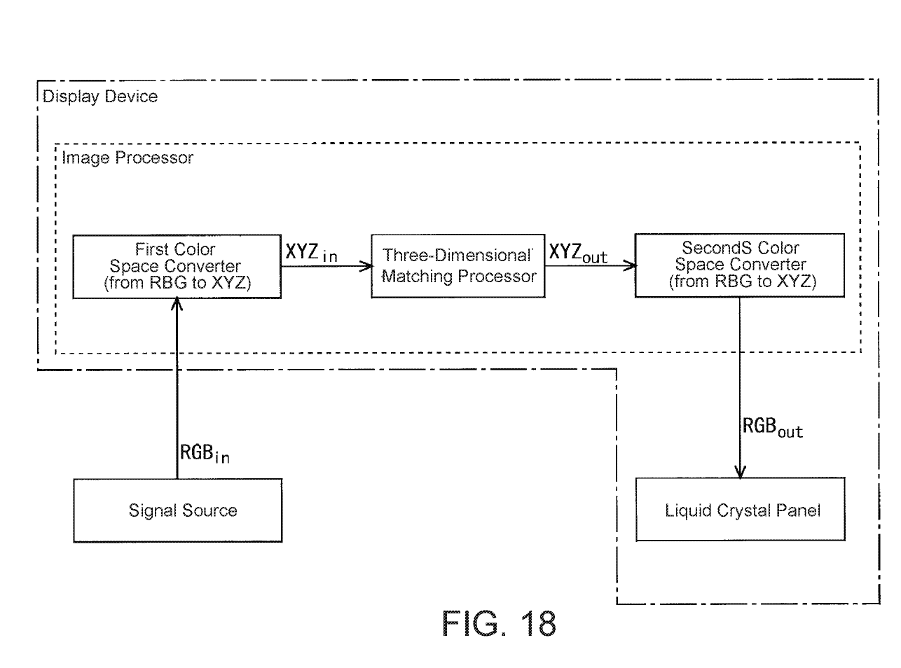

### DETAILED DESCRIPTION OF EMBODIMENTS

Next, embodiments of the present invention will be described with reference to the attached figures.

### 1. Embodiment 1

### 1.1 Overall Configuration and Overview of Operation

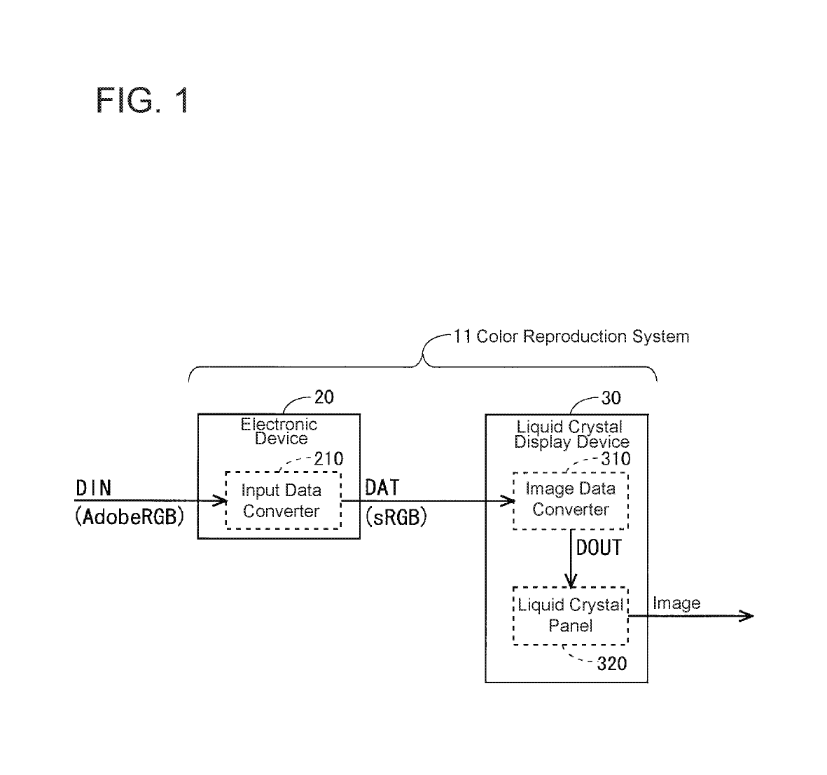

FIG. 1 is a block diagram illustrating an overall configuration of a color reproduction system 11 according to Embodiment 1 of the present invention. As illustrated in FIG. 1, this color reproduction system 11 includes an electronic device 20 and a liquid crystal display device 30. The electronic device 20 includes an input data converter 210. The liquid crystal display device 30 includes an image data converter 310 and a liquid crystal panel 320.

The input data converter 210 performs a color gamut conversion process on input data DIN that is input to the electronic device 20. The color gamut conversion process performed by the input data converter 210 produces image data DAT, which is then sent from the electronic device 20 to the liquid crystal display device 30. The image data converter 310 performs a color gamut conversion process on the image data DAT sent to the liquid crystal display device 30, and the data resulting from that color gamut conversion process is sent to the liquid crystal panel 320 as display data DOUT. The liquid crystal panel 320 uses the display data DOUT to display a color image for viewing. In the present embodiment, it is assumed that the liquid crystal panel 320 exhibits a linear relationship between the gradation values of the display data DOUT input thereto and the resulting display brightness.

In the present embodiment, it is assumed that the input data DIN that is input to the electronic device 20 is compliant with the Adobe RGB standard. Moreover, in this color reproduction system 11, the image data DAT sent from the electronic device 20 to the liquid crystal display device 30 is compliant with the sRGB standard. Therefore, the input data converter 210 of the electronic device 20 converts Adobe RGB data to sRGB data. Furthermore, the image data converter 310 of the liquid crystal display device 30 converts the sRGB data to data for the liquid crystal panel 320.

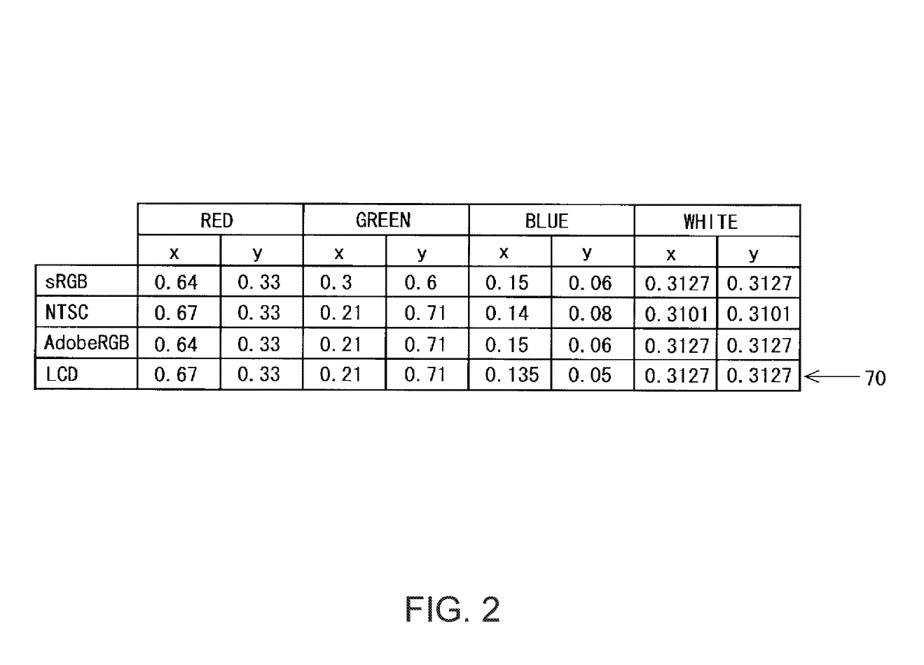

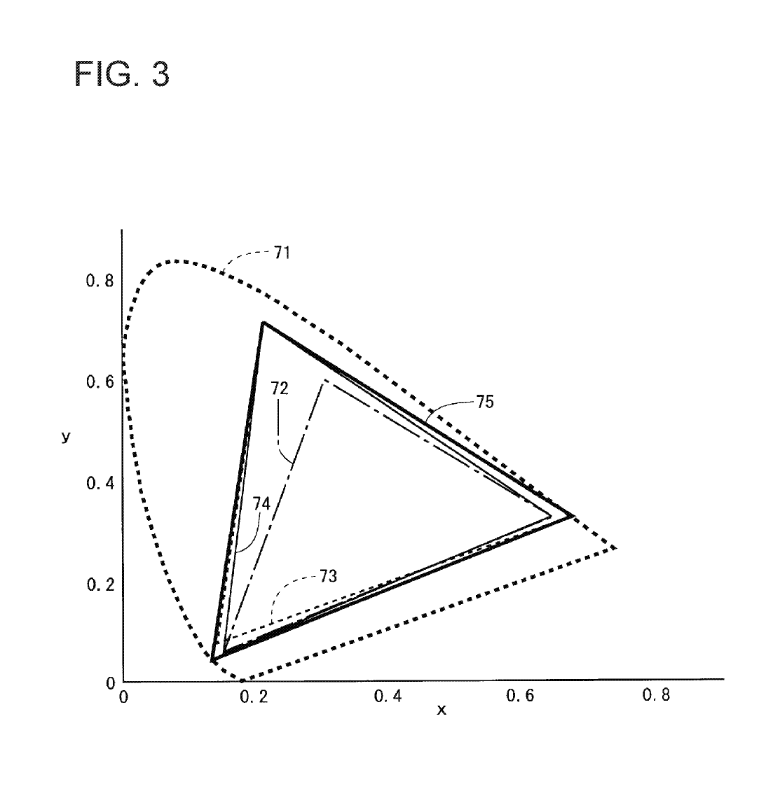

FIG. 2 is a table showing the chromaticity coordinates of the primary colors and a white point in several common standard color spaces. Moreover, the row indicated by the arrow 70 in FIG. 2 contains the values for the liquid crystal panel 320 of the present embodiment. FIG. 3 is an xy chromaticity diagram showing the color gamuts of several common standard color spaces. In FIG. 3, the curve 71 represents the range of all colors that can be seen by the human eye. The triangle 72 represents the gamut of the sRGB color space. The triangle 73 represents the gamut of the NTSC color space. The triangle 74 represents the gamut of the Adobe RGB color space. The triangle 75 represents the color gamut of the liquid crystal panel 320 of the present embodiment. As shown in FIGS. 2 and 3, the color gamut of the liquid crystal panel 320 of the present embodiment completely encompasses the gamut of the sRGB color space, the gamut of the NTSC color space, and the gamut of the Adobe RGB color space. Moreover, as shown in FIG. 2, the chromaticity coordinates of the white point of the liquid crystal panel 320 of the present embodiment match the chromaticity coordinates of the white points of the sRGB color space and the Adobe RGB color space.

### 1.2 Color Gamut Conversion Process

Next, the color gamut conversion process will be described in more detail. As described above, in the present embodiment, the input data converter 210 of the electronic device 20 and the image data converter 310 of the liquid crystal display device 30 both implement a color gamut conversion process. In the following description, components such as the input data converter 210 and the image data converter 310 that implement a color gamut conversion process will be referred to simply as “color gamut converters”.

First, a method for converting tristimulus values in the RGB color system to tristimulus values in the XYZ color system will be described. When using the RGB color system, the actual representation of colors is dependent on the color space or device used. In contrast, the XYZ color system provides a method of color representation that is not dependent on the color space or device used. In other words, although RGB values do not necessarily represent colors accurately, XYZ values uniquely define every color.

Here, it is assumed that the three primaries R, G, and B can take values in the range of greater than or equal to 0 and less than or equal to 1. Moreover, let the chromaticity coordinates of the R stimulus value be x_{R}, y_{R}, and z_{R}; let the chromaticity coordinates of the G stimulus value be x_{G}, y_{G}, and z_{G}; and let the chromaticity coordinates of the B stimulus value be x_{B}, y_{B}, and z_{B}. In this case, the x_{R}, y_{R}, and z_{R} chromaticity coordinates for all RGB tristimulus values for which R≠0 and G=0 and B=0, for example, are constant, while the XYZ values in the XYZ color system change according to the R value. This also applies to the x_{G}, y_{G}, and z_{G} chromaticity coordinates as well as to the x_{B}, y_{B}, and z_{B} chromaticity coordinates. Below, let the XYZ values in the XYZ color system be X_{R}, Y_{R}, and Z_{R}.

When just the R stimulus value of the three primaries is set to the maximum value (that is, when R=1, G=0, and B=0), the xyz chromaticity coordinates are given by equation (1). Note that here, S_{R}=X_{R}+Y_{R}+Z_{R}.

$$\begin{matrix}< \#1 > & \\ {x}_{R} = \frac{{X}_{R}}{{S}_{R}} ; \\ {y}_{R} = \frac{{Y}_{R}}{{S}_{R}} ; \\ {z}_{R} = \frac{{Z}_{R}}{{S}_{R}} & ( 1 )\end{matrix}$$

Furthermore, when R≠0 and G=0 and B=0, the XYZ values for any value of R are given by equation (2).

<#2>

X=RX_{R};Y=RY_{R};Z=RZ_{R} (2)

When just the G stimulus value of the three primaries is set to the maximum value (that is, when R=0, G=1, and B=0), the xyz chromaticity coordinates are given by equation (3). Note that here, S_{G}=X_{G}+Y_{G}+Z_{G}.

$$\begin{matrix}< \#3 > & \\ {x}_{G} = \frac{{X}_{G}}{{S}_{G}} ; \\ {y}_{G} = \frac{{Y}_{G}}{{S}_{G}} ; \\ {z}_{G} = \frac{{Z}_{G}}{{S}_{G}} & ( 3 )\end{matrix}$$

Furthermore, when R=0 and G≠0 and B=0, the XYZ values for any value of G are given by equation (4).

<#4>

X=GX_{G};Y=GY_{G};Z=GZ_{G} (4)

When just the B stimulus value of the three primaries is set to the maximum value (that is, when R=0, G=0, and B=1), the xyz chromaticity coordinates are given by equation (5). Note that here, S_{B}=X_{B}+Y_{B}+Z_{B}.

$$\begin{matrix}< \#5 > & \\ {x}_{B} = \frac{{X}_{B}}{{S}_{B}} ; \\ {y}_{B} = \frac{{Y}_{B}}{{S}_{B}} ; \\ {z}_{B} = \frac{{Z}_{B}}{{S}_{B}} & ( 5 )\end{matrix}$$

Furthermore, when R=0 and G=0 and B≠0, the XYZ values for any value of B are given by equation (6).

<#6>

X=BX_{B};Y=BY_{B};Z=BZ_{B} (6)

When the three primaries R, G, and B all have non-zero values, the XYZ values in the XYZ color system are the sums of each individual stimulus value. Therefore, combining equations (2), (4), and (6) above yields equation (7).

$$\begin{matrix}< \#7 > & \\ \begin{matrix}X = {RX}_{R} + {GX}_{G} + {BX}_{B} \\ Y = {RY}_{R} + {GY}_{G} + {BY}_{B} \\ Z = {RZ}_{R} + {GZ}_{G} + {BZ}_{B}\end{matrix} \} & ( 7 )\end{matrix}$$

In matrix notation, equation (7) becomes equation (8).

$$\begin{matrix}< \#8 > & \\ ( \begin{matrix}X \\ Y \\ Z\end{matrix} ) = ( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} ) ( \begin{matrix}R \\ G \\ B\end{matrix} ) & ( 8 )\end{matrix}$$

Equation (8) thus defines the method for converting tristimulus values in the RGB color system to tristimulus values in the XYZ color system.

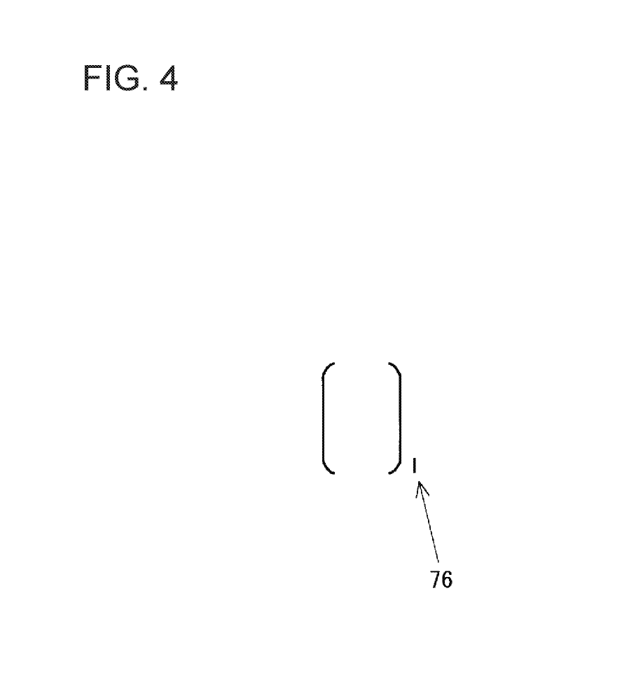

In the following matrix equations, the subscript “I” as indicated by the arrow 76 in FIG. 4 is used to indicate input signals, and the subscript “O” as indicated by the arrow 77 in FIG. 4 is used to indicate output signals. From equation (8), the XYZ values for colors that can be reproduced by input signals to a color gamut converter are given by equation (9). Moreover, the XYZ values for colors that can be reproduced by output signals from the color gamut converter are given by equation (10).

$$\begin{matrix}< \#9 > & \\ ( \begin{matrix}X \\ Y \\ Z\end{matrix} ) = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{1} {( \begin{matrix}R \\ G \\ B\end{matrix} )}_{1} & ( 9 ) \\ < \#10 > & \\ ( \begin{matrix}X \\ Y \\ Z\end{matrix} ) = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{0} {( \begin{matrix}R \\ G \\ B\end{matrix} )}_{0} & ( 10 )\end{matrix}$$

The right side of equation (9) is equal to the right side of equation (10), thereby yielding equation (11).

$$\begin{matrix}< \#11 > & \\ {( \begin{matrix}R \\ G \\ B\end{matrix} )}_{0} = \frac{{( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{1}}{{{( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{0}}_{{{⏟}_{≀}}_{78}}} \times {( \begin{matrix}R \\ G \\ B\end{matrix} )}_{1} & ( 11 )\end{matrix}$$

Letting the quantity indicated by the reference character 78 in equation (11) be T, equation (11) becomes equation (12).

$$\begin{matrix}< \#12 > & \\ {( \begin{matrix}R \\ G \\ B\end{matrix} )}_{0} = T \times {( \begin{matrix}R \\ G \\ B\end{matrix} )}_{1} & ( 12 )\end{matrix}$$

This quantity T can also be represented as shown in equation (13). Below, this quantity T will be referred to as a “conversion coefficient.”

$$\begin{matrix}< \#13 > & \\ T = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{0}^{- 1} {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{1} & ( 13 )\end{matrix}$$

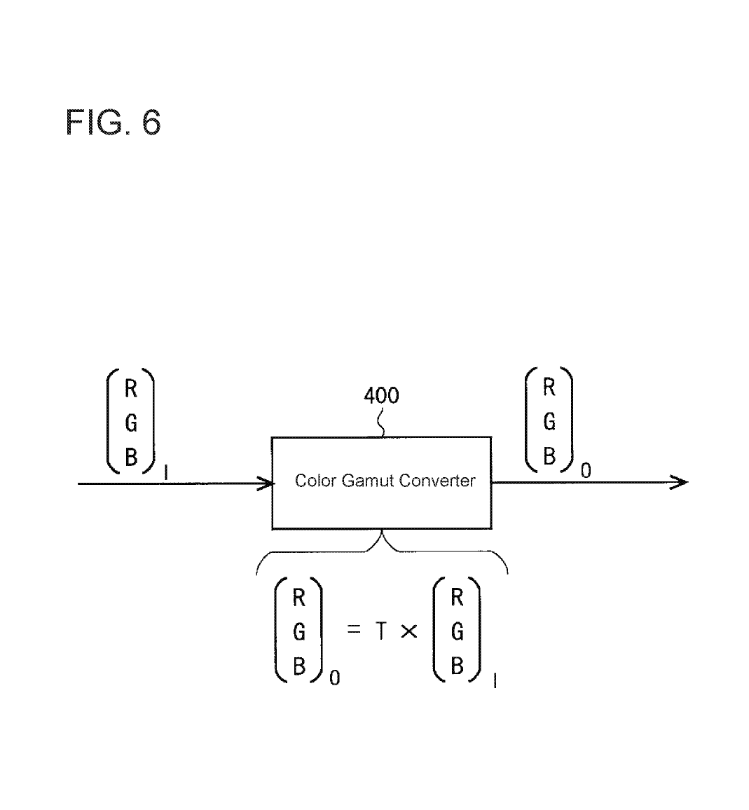

Therefore, as illustrated in FIG. 6, in the present embodiment a color gamut converter 400 performs equation (12) (using the conversion coefficient T as calculated from equation (13)) on color values included in an input signal in order to convert the input signal to an output signal. The color gamut conversion processes implemented in the electronic device 20 and in the liquid crystal display device 30 are based on this technique and will be described next.

### 1.3 Process Implemented in Electronic Device

The electronic device 20 includes the input data converter 210, which functions as the color gamut converter 400 described above. In the present embodiment, the input data DIN that is input to the electronic device 20 is compliant with the Adobe RGB standard. Moreover, in the present embodiment, the image data DAT sent from the electronic device 20 to the liquid crystal display device 30 is compliant with the sRGB standard. Therefore, the input signal that is input to the input data converter 210 is Adobe RGB data, and the output signal that is output from the input data converter 210 is sRGB data.

From equations (9) to (13) above, the conversion coefficient T_{Adobe→sRGB} for when the input signal is Adobe RGB data and the output signal is sRGB data is given by equation (14).

$$\begin{matrix}< \#14 > & \\ {T}_{Adobe \to sRGB} = ( \begin{matrix}1.3984 & - 0.3984 & 0.0000 \\ 0.0000 & 1.0000 & 0.0000 \\ 0.0000 & - 0.412 & 1.0429\end{matrix} ) & ( 14 )\end{matrix}$$

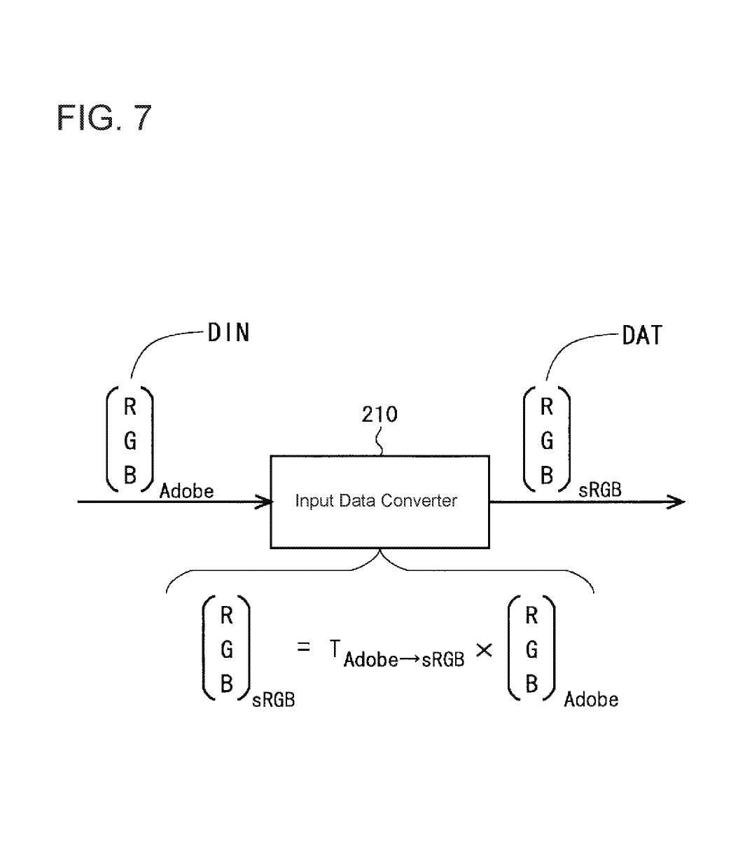

Therefore, as illustrated in FIG. 7, the input data converter 210 of the electronic device 20 performs a color gamut conversion process using the conversion coefficient T_{Adobe→sRGB} to the Adobe RGB input data DIN in order to generate the sRGB image data DAT.

### 1.4 Process Implemented in Liquid Crystal Display Device

The liquid crystal display device 30 includes the image data converter 310, which functions as the color gamut converter 400 described above. In the present embodiment, the image data DAT input on the image data converter 310 is compliant with the sRGB standard. Furthermore, the image data converter 310 performs a color gamut conversion process on the sRGB image data DAT in order to generate display data DOUT for the liquid crystal panel 320. In other words, the input signal that is input to the image data converter 310 is sRGB data, and the output signal that is output from the image data converter 310 is data that is formatted appropriately for the color gamut of the liquid crystal panel 320.

From equations (9) to (13) above, the conversion coefficient T_{sRGB→LCD} for when the input signal is sRGB data and the output signal is data that is formatted appropriately for the color gamut of the liquid crystal panel 320 is given by equation (15).

$$\begin{matrix}< \#15 > & \\ {T}_{sRGB \to LCD} = ( \begin{matrix}0.6871 & 0.2753 & 0.0376 \\ 0.0179 & 0.9775 & 0.0046 \\ 0.0177 & 0.0472 & 0.9351\end{matrix} ) & ( 15 )\end{matrix}$$

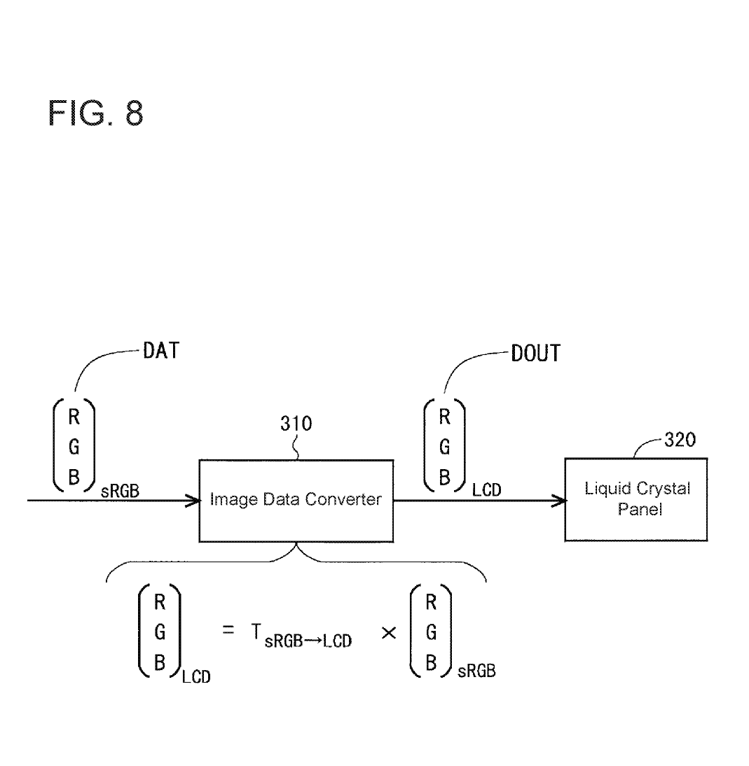

Therefore, as illustrated in FIG. 8, the image data converter 310 of the liquid crystal display device 30 performs a color gamut conversion process using the conversion coefficient T_{sRGB→LCD} on the sRGB image data DAT in order to generate the display data DOUT for the liquid crystal panel 320.

### 1.5 Color Gamut Conversion Process Example

Next, some specific examples of the color gamut conversion process will be described. In the following matrix equations, the subscript “Adobe” is used to indicate Adobe RGB data, the subscript “sRGB” is used to indicate sRGB data, and the subscript “LCD” is used to indicate data for the liquid crystal panel 320.

First, assume that the input data DIN that is input to the electronic device 20 is given by equation (16) (below, this data will be referred to simply as “target data”).

$$\begin{matrix}< \#16 > & \\ {( \begin{matrix}R \\ G \\ B\end{matrix} )}_{Adobe} = ( \begin{matrix}1 \\ 0 \\ 0\end{matrix} ) & ( 16 )\end{matrix}$$

In this case, the input data converter 210 performs the color gamut conversion process using the conversion coefficient T_{Adobe→sRGB} on the input data DIN in order to generate the image data DAT that includes the target data given by equation (17).

$$\begin{matrix}< \#17 > & \\ {( \begin{matrix}R \\ G \\ B\end{matrix} )}_{sRGB} = ( \begin{matrix}1.3984 \\ 0 \\ 0\end{matrix} ) & ( 17 )\end{matrix}$$

Furthermore, the image data converter 310 performs the color gamut conversion process using the conversion coefficient T_{sRGB→LED} on the image data DAT in order to generate the display data DOUT that includes the target data given by equation (18).

$$\begin{matrix}< \#18 > & \\ {( \begin{matrix}R \\ G \\ B\end{matrix} )}_{LCD} = ( \begin{matrix}0.9608 \\ 0.0250 \\ 0.0248\end{matrix} ) & ( 18 )\end{matrix}$$

Finally, the liquid crystal panel 320 displays an image using the display data DOUT generated by the image data converter 310.

Next, assume that the input data DIN that is input to the electronic device 20 is given by equation (19) (below, this data will be referred to simply as “target data”).

$$\begin{matrix}< \#19 > & \\ {( \begin{matrix}R \\ G \\ B\end{matrix} )}_{Adobe} = ( \begin{matrix}0 \\ 1 \\ 0\end{matrix} ) & ( 19 )\end{matrix}$$

In this case, the input data converter 210 performs the color gamut conversion process using the conversion coefficient T_{Adobe→sRGB} on the input data DIN in order to generate the image data DAT that includes the target data given by equation (20).

$$\begin{matrix}< \#20 > & \\ {( \begin{matrix}R \\ G \\ B\end{matrix} )}_{sRGB} = ( \begin{matrix}- 0.3984 \\ 1.0000 \\ - 0.0429\end{matrix} ) & ( 20 )\end{matrix}$$

Furthermore, the image data converter 310 performs the color gamut conversion process using the conversion coefficient T_{sRGB→LCD} on the image data DAT in order to generate the display data DOUT that includes the target data given by equation (21).

$$\begin{matrix}< \#21 > & \\ {( \begin{matrix}R \\ G \\ B\end{matrix} )}_{LCD} = ( \begin{matrix}0.0000 \\ 0.9702 \\ 0.0000\end{matrix} ) & ( 21 )\end{matrix}$$

Finally, the liquid crystal panel 320 displays an image using the display data DOUT generated by the image data converter 310.

The gamut of the sRGB color space is smaller than the gamut of the Adobe RGB color space. Therefore, as shown above in equations (17) and (20), the data resulting from the color gamut conversion process implemented by the input data converter 210 of the electronic device 20 includes values that are greater than 1 as well as negative values. Similarly, the color gamut of the liquid crystal panel 320 of the present embodiment is larger than the gamut of the Adobe RGB color space. Therefore, as shown above in equations (18) and (21), the data resulting from the color gamut conversion process implemented by the image data converter 310 of the liquid crystal display device 30 only includes values that are greater than or equal to 0 and less than or equal to 1.

Moreover, as described above, the chromaticity coordinates of the white point of the liquid crystal panel 320 of the present embodiment match the chromaticity coordinates of the white points of the sRGB color space and the Adobe RGB color space. However, even if the chromaticity coordinates of the white point of the liquid crystal panel 320 are different than the chromaticity coordinates of the white point of the sRGB color space, a process for converting the chromaticity coordinates of the white point of the sRGB color space to the chromaticity coordinates of the white point of the liquid crystal panel 320 may simply be performed prior to the color gamut conversion process implemented by the image data converter 310.

### 1.6 Effects

In the color reproduction system 11 of the present embodiment that includes the liquid crystal display device 30 and a primary device thereof (the electronic device 20), sRGB is set in advance as the standard for data sent from the electronic device 20 to the liquid crystal display device 30. Therefore, the electronic device 20 may implement the color gamut conversion process for converting the input data DIN to sRGB data regardless of the color gamut of the liquid crystal panel 320. In this way, the electronic device 20 may generate data compliant with any predefined standard. Moreover, the liquid crystal display device 30 may implement any color gamut conversion process appropriate for the color gamut of the liquid crystal panel 320. Therefore, the electronic device 20 can implement the necessary process without requiring any information from the liquid crystal display device 30, and the liquid crystal display device 30 can implement the necessary process without requiring any information from the electronic device 20. This makes it possible to design and manufacture the electronic device 20 and the liquid crystal display device 30 completely independently of one another. This, in turn, reduces the burden associated with color reproduction on manufacturers. Moreover, the implementations of the processes can be defined in advance, thereby making it unnecessary to determine various parameters using an online process. This makes it possible to produce color reproduction systems more easily than when using conventional technologies and reduces the costs of producing of color reproduction systems. Furthermore, the data sent to the liquid crystal display device 30 is based on a predefined standard that does not depend on the electronic device 20 connected thereto, thereby preventing variation in the colors represented by that data. This prevents differences in display image coloring due to the primary device (the electronic device 20). Therefore, the present embodiment makes it possible to provide a color reproduction system that prevents differences in display image coloring due to the primary device and can also be produced more easily than when using conventional technologies.

### 1.7 Modification Examples

Color reproduction systems in which the color gamut conversion process can be switched between the color gamut conversion process implemented using the method described above in Embodiment 1 and a color gamut conversion process implemented using a conventional method are also possible. In other words, a plurality of selectable operation modes may be prepared in advance, and the electronic device 20 and the liquid crystal display device 30 may apply the color gamut conversion process implemented using the method described above in Embodiment 1 when a prescribed operation mode is selected. In this case, when the prescribed operation mode of the plurality of operation modes that are prepared in advance is selected, only sRGB data is sent from the electronic device 20 to the liquid crystal display device 30 as the image data DAT, and when another operation mode is selected, data compliant with a standard other than sRGB is sent from the electronic device 20 to the liquid crystal display device 30 as the image data DAT. Similarly, configurations in which the color gamut conversion process can be switched between color gamut conversion processes implemented using the methods described in the following embodiments and a color gamut conversion process implemented using a conventional method are also possible.

### 2. Embodiment 2

### 2.1 Configuration

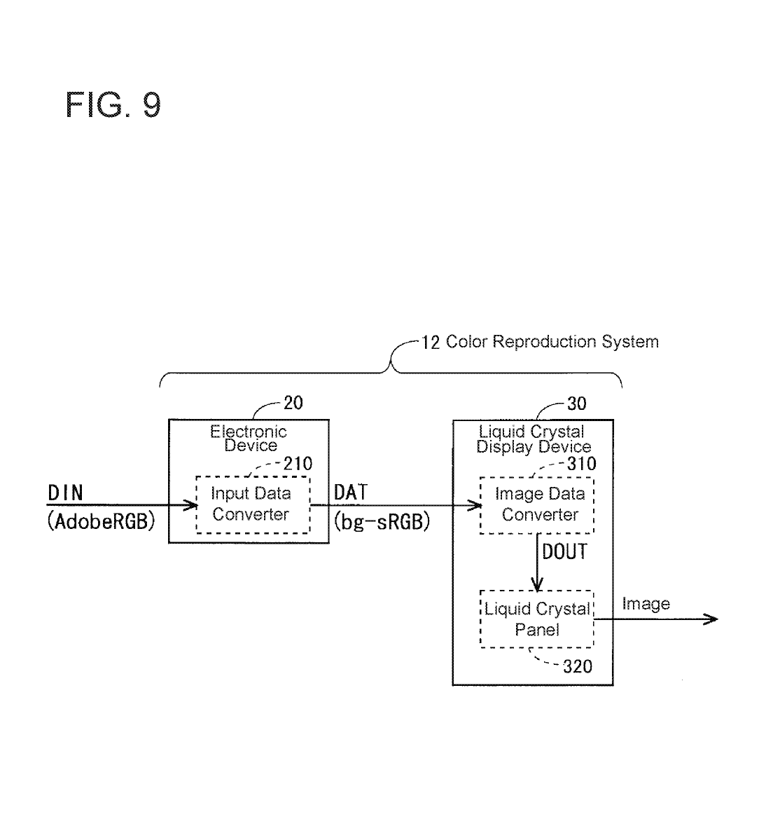

FIG. 9 is a block diagram illustrating an overall configuration of a color reproduction system 12 according to Embodiment 2 of the present invention. In the following description, only the aspects of Embodiment 2 that are different than Embodiment 1 will be described in detail. As in Embodiment 1, a color reproduction system 12 according to the present embodiment includes an electronic device 20 and a liquid crystal display device 30. In Embodiment 1, the image data DAT sent from the electronic device 20 to the liquid crystal display device 30 is compliant with the sRGB standard. However, in the present embodiment, the image data DAT sent from the electronic device 20 to the liquid crystal display device 30 is compliant with the bg-sRGB standard. The present embodiment is the same as Embodiment 1 except in that bg-sRGB data is sent from the electronic device 20 to the liquid crystal display device 30.

Next, the bg-sRGB color space will be described. The bg-sRGB standard was created as an amendment to the sRGB standard in order to be able to represent a larger gamut of colors than can be represented in the standard sRGB color space. In the sRGB color space, RGB values are represented as values greater than or equal to 0 and less than or equal to 1. In the bg-sRGB color space, however, RGB values can be represented as negative values and values greater than 1 in addition to the values greater than or equal to 0 and less than or equal to 1. Linear RGB values can be represented as values greater than or equal to −0.524 and less than or equal to 1.675. Non-linear RGB values can be represented as values greater than or equal to −0.751 and less than or equal to 1.253. Moreover, in the bg-sRGB color space, gradation values are represented using 10 or more bits. However, the present embodiment assumes use of 10-bit gradation values.

The input data converter 210 of the electronic device 20 performs a color gamut conversion process on the Adobe RGB input data DIN in order to generate 10-bit bg-sRGB image data DAT. Moreover, the image data converter 310 of the liquid crystal display device 30 performs a color gamut conversion process on the 10-bit image data DAT in order to generate display data DOUT for the liquid crystal panel 320.

### 2.2 Effects

The present embodiment makes it possible to achieve the following effects in addition to the effects achieved in Embodiment 1. In the present embodiment, the image data DAT sent from the electronic device 20 to the liquid crystal display device 30 is compliant with the bg-sRGB standard. This makes it possible for the image data DAT that is sent from the electronic device 20 to the liquid crystal display device 30 to include RGB values that are negative or greater than 1. As a result, data that represents colors of a larger gamut than that of the standard sRGB color space can be sent from the electronic device 20 to the liquid crystal display device 30. This makes it possible to reproduce a colors of a larger gamut than that of the standard sRGB color space on the liquid crystal panel 320 (as long as those colors are not outside of the color gamut of the liquid crystal panel 320 itself).

### 3. Embodiment 3

### 3.1 Configuration

In Embodiments 1 and 2, it was assumed that the liquid crystal panel 320 exhibits a linear relationship between the gradation values of the input signal (the display data DOUT) input thereto and the resulting display brightness. However, in most cases the liquid crystal panel 320 will exhibit non-linear characteristics. Therefore, the present embodiment assumes use of a liquid crystal panel 320 that has non-linear characteristics.

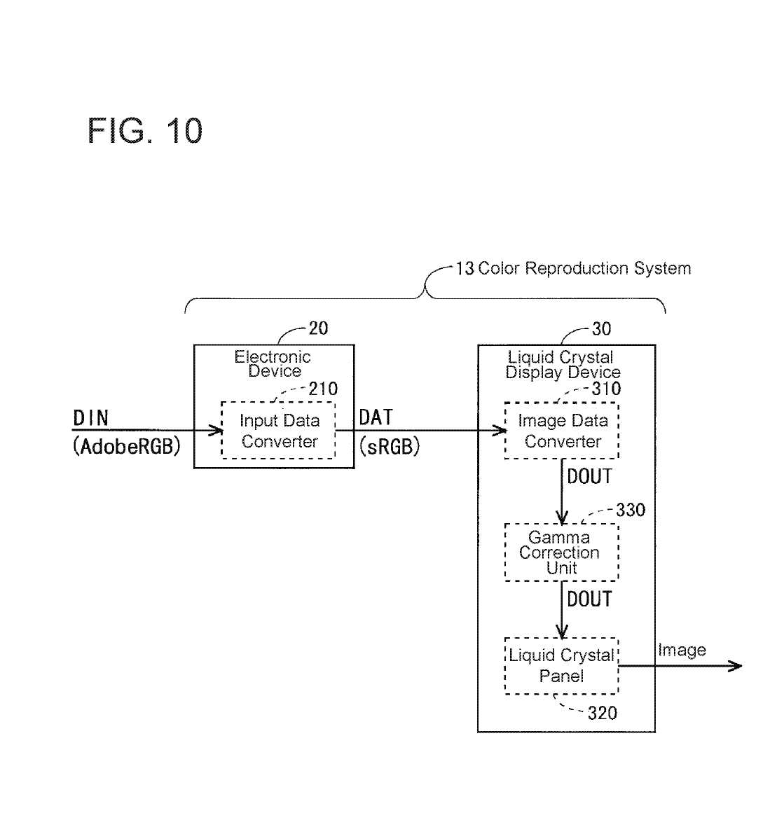

FIG. 10 is a block diagram illustrating an overall configuration of a color reproduction system 13 according to Embodiment 3 of the present invention Like in Embodiment 1, this color reproduction system 13 includes an electronic device 20 and a liquid crystal display device 30. The electronic device 20 is configured the same as in Embodiment 1 (see FIG. 1). The liquid crystal display device 30 is configured the same as in Embodiment 1 but also includes a gamma correction processor 330. This gamma correction processor 330 functions as a display data gamma correction processor. The gamma correction processor 330 performs a gamma correction process on display data DOUT generated by the image data converter 310. The gamma correction process performed by the gamma correction processor 330 is implemented according to the gamma characteristics of the liquid crystal panel 320.

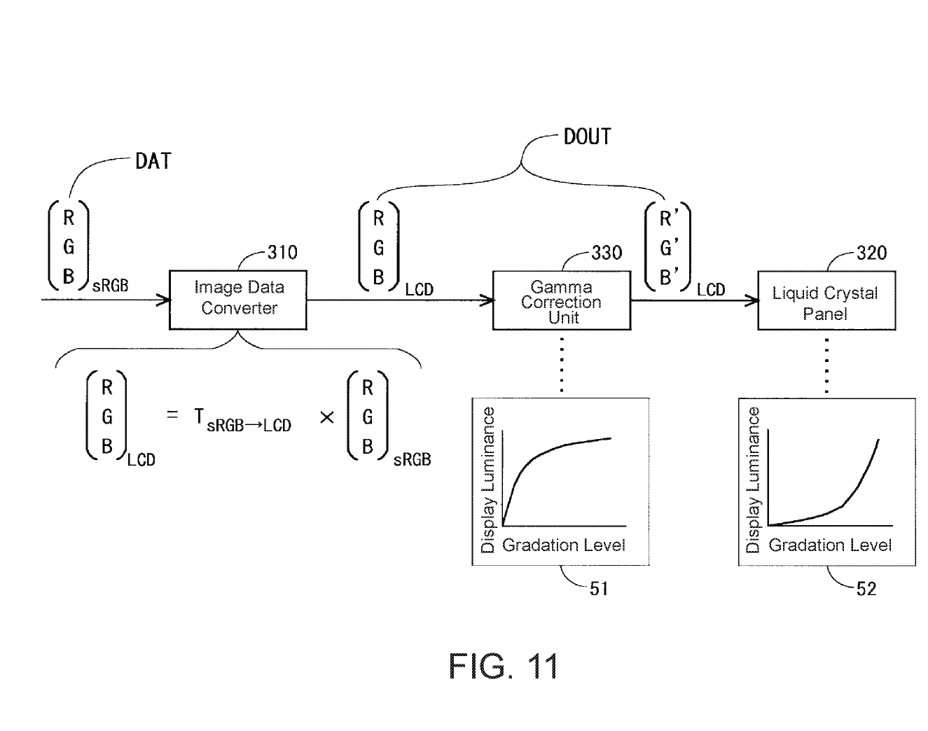

As illustrated in FIG. 8, in Embodiment 1 the display data DOUT generated by the image data converter 310 is sent directly to the liquid crystal panel 320. However, as illustrated in FIG. 11, in the present embodiment the gamma correction process is performed on the display data DOUT generated by the image data converter 310, and then the gamma-corrected display data DOUT is sent to the liquid crystal panel 320. To achieve this, in the present embodiment the gamma correction processor 330 is arranged downstream of the image data converter 310. Furthermore, when the liquid crystal panel 320 has the output characteristics indicated by reference character 52 in FIG. 11, for example, the gamma correction processor 330 performs the gamma correction process indicated by reference character 51 in FIG. 11 on the display data DOUT generated by the image data converter 310. In this way, in the present embodiment the gamma correction process is performed on the display data DOUT for the liquid crystal panel 320.

### 3.2 Effects

The present embodiment makes it possible to achieve the following effects in addition to the effects achieved in Embodiment 1. In the present embodiment, after the display data DOUT for the liquid crystal panel 320 is generated by the image data converter 310 of the liquid crystal display device 30, the gamma correction process is performed on that display data DOUT. Therefore, even when the liquid crystal panel 320 exhibits a non-linear relationship between the gradation values in the input signal (the display data DOUT) input thereto and the resulting display brightness, the colors represented in the input data DIN input to the electronic device 20 can still be reproduced accurately on the liquid crystal panel 320.

### 4. Embodiment 4

### 4.1 Configuration

Typically, the input signal sent to a liquid crystal display device is a gamma-corrected signal. Therefore, in the present embodiment, gamma-corrected image data DAT is sent from an electronic device 20 to a liquid crystal display device 30. Moreover, like in Embodiment 3, in the present embodiment a liquid crystal panel 320 has non-linear characteristics.

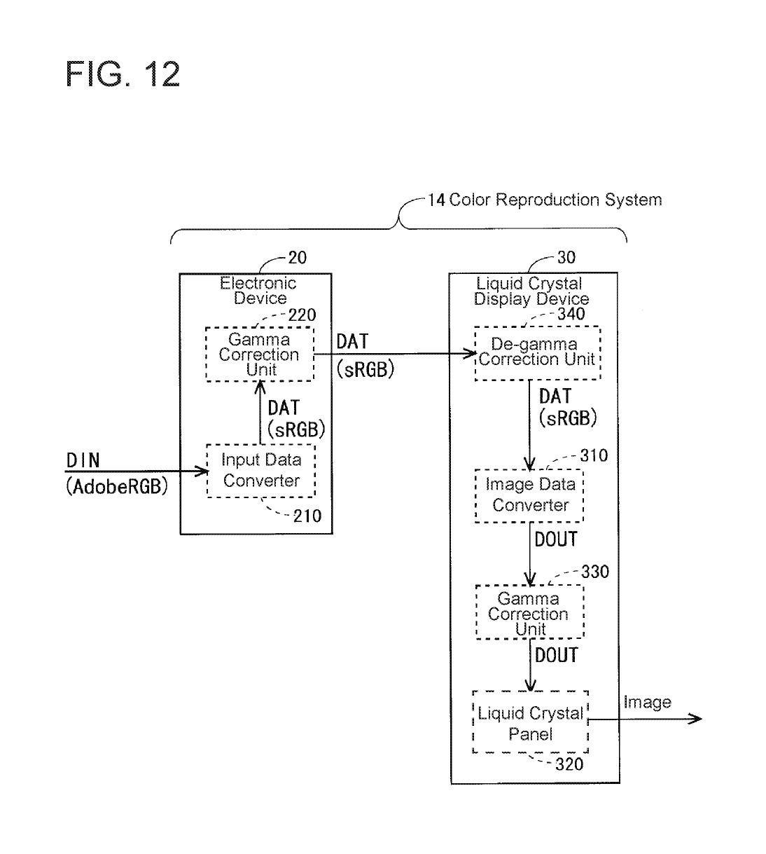

FIG. 12 is a block diagram illustrating an overall configuration of a color reproduction system 14 according to Embodiment 4 of the present invention Like in Embodiment 1, this color reproduction system 14 includes the electronic device 20 and the liquid crystal display device 30. The electronic device 20 is configured the same as in Embodiment 1 but also includes a gamma correction processor 220. The gamma correction processor 220 performs a gamma correction process on the image data DAT generated by the input data converter 210. The liquid crystal display device 30 is configured the same as in Embodiment 1 but also includes a de-gamma correction processor 340 and a gamma correction processor 330. The de-gamma correction processor 340 performs a de-gamma correction process on the image data DAT sent from the electronic device 20. The gamma correction processor 330 performs a gamma correction process on display data DOUT generated by the image data converter 310. Moreover, in the present embodiment the gamma correction processor 220 of the electronic device 20 functions as an image data gamma correction processor, and the gamma correction processor 330 of the liquid crystal display device 30 functions as a display data gamma correction processor.

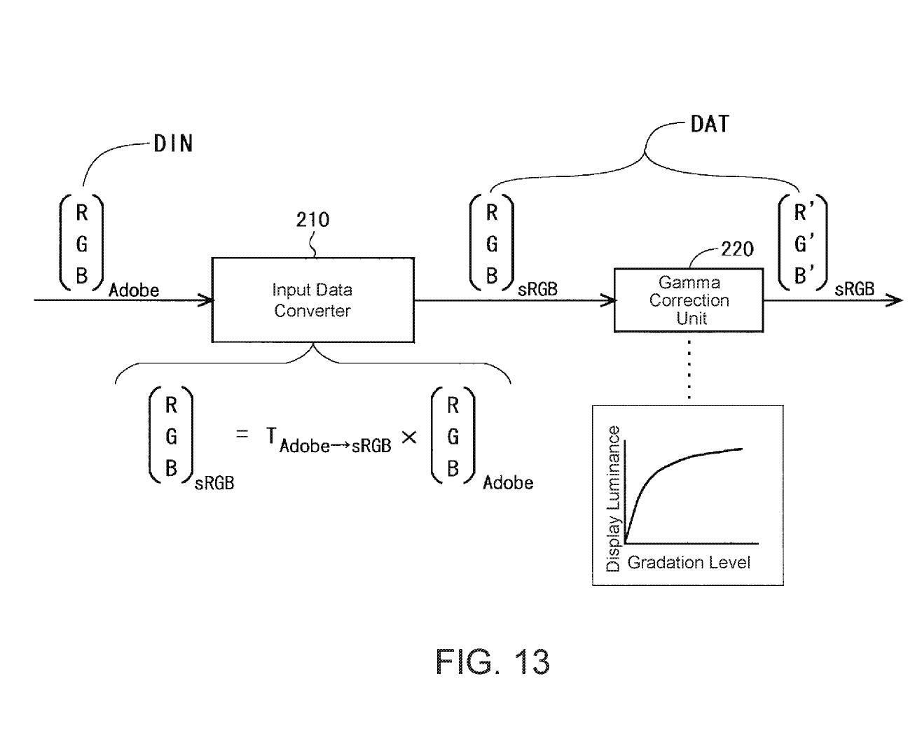

As illustrated in FIG. 7, in Embodiment 1 the image data DAT generated by the input data converter 210 is sent directly to the liquid crystal display device 30. However, as illustrated in FIG. 13, in the present embodiment a gamma correction process is performed on the image data DAT generated by the input data converter 210, and then the gamma-corrected image data DAT is sent to the liquid crystal display device 30. To achieve this, in the present embodiment the gamma correction processor 220 is arranged downstream of the input data converter 210. In this way, in the present embodiment a gamma correction process is performed on the image data DAT sent to the liquid crystal display device 30.

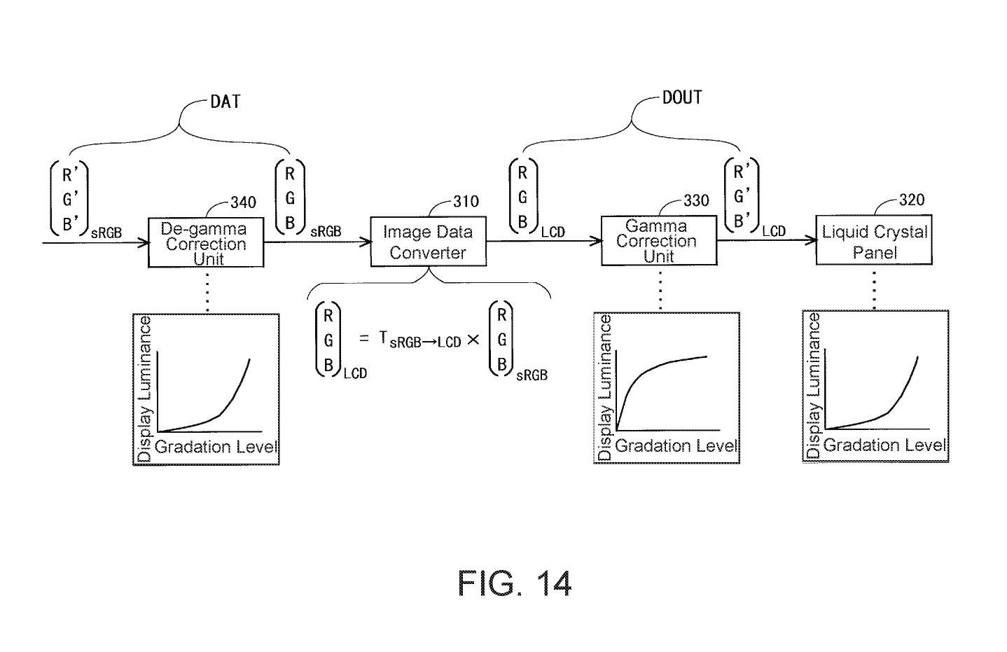

Moreover, as illustrated in FIG. 8, in Embodiment 1 the image data DAT sent from the electronic device 20 is input directly to the image data converter 310. However, as illustrated in FIG. 14, in the present embodiment a de-gamma correction process is performed on the image data DAT sent from the electronic device 20, and then the de-gamma-corrected image data DAT is input to the image data converter 310. To achieve this, in the present embodiment the de-gamma correction processor 340 is arranged upstream of the image data converter 310. In this way, in the present embodiment a de-gamma correction process is performed on the image data DAT sent from the electronic device 20.

Furthermore, as illustrated in FIG. 8, in Embodiment 1 the display data DOUT generated by the image data converter 310 is sent directly to the liquid crystal panel 320. However, as illustrated in FIG. 14, in the present embodiment a gamma correction process is performed on the display data DOUT generated by the image data converter 310, and then the gamma-corrected display data DOUT is sent to the liquid crystal panel 320. To achieve this, in the present embodiment the gamma correction processor 330 is arranged downstream of the image data converter 310. In this way, in the present embodiment a gamma correction process is performed on the display data DOUT for the liquid crystal panel 320.

### 4.2 Gamma Correction Process/De-Gamma Correction Process Examples

The gamma correction processor 220 of the electronic device 20 performs an sRGB gamma correction process. More specifically, as shown in equations (22) to (24), the linear RGB values (R_{sRGB}, G_{sRGB}, B_{sRGB}) before gamma correction are converted to non-linear RGB values (R′_{sRGB}, G′_{sRGB}, B′_{sRGB}) according to the respective magnitudes of the linear RGB values.

$$\begin{matrix}< \#22 > & \\ \begin{matrix}if {R}_{sRGB} ≦ 0.0031308 \\ {R}_{sRGB}^{′} = {R}_{sRGB} \times 12.92 \\ if {R}_{sRGB} > 0.0031308 \\ {R}_{sRGB}^{′} = 1.055 \times {R}_{sRGB}^{1 / 2.4} - 0.055\end{matrix} \} & ( 22 ) \\ < \#23 > & \\ \begin{matrix}if {G}_{sRGB} ≦ 0.0031308 \\ {G}_{sRGB}^{′} = {G}_{sRGB} \times 12.92 \\ if {G}_{sRGB} > 0.0031308 \\ {G}_{sRGB}^{′} = 1.055 \times {G}_{sRGB}^{1 / 2.4} - 0.055\end{matrix} \} & ( 23 ) \\ < \#24 > & \\ \begin{matrix}if {B}_{sRGB} ≦ 0.0031306 \\ {B}_{sRGB}^{′} = {B}_{sRGB} \times 12.92 \\ if {B}_{sRGB} > 0.0031308 \\ {B}_{sRGB}^{′} = 1.055 \times {B}_{sRGB}^{1 / 2.4} - 0.055\end{matrix} \} & ( 24 )\end{matrix}$$

Next, the de-gamma correction processor 340 of the liquid crystal display device 30 performs an sRGB de-gamma correction process. More specifically, as shown in equations (25) to (27), the non-linear RGB values (R′_{sRGB}, G′_{sRGB}, B′_{sRGB}) before de-gamma correction are converted to linear RGB values (R_{sRGB}, G_{sRGB}, B_{sRGB}) according to the respective magnitudes of the non-linear RGB values.

$$\begin{matrix}< \#25 > & \\ \begin{matrix}if {R}_{sRGB}^{′} ≦ 0.04045 \\ {R}_{sRGB} = {R}_{sRGB}^{′} \div 12.92 \\ if {{R}^{′}}_{sRGB} > 0.04045 \\ {R}_{sRGB} = {( ( {R}_{sRGB}^{′} + 0.055 ) \div 1.055 )}^{2.4}\end{matrix} \} & ( 25 ) \\ < \#26 > & \\ \begin{matrix}if {G}_{sRGB}^{′} ≦ 0.04045 \\ {G}_{sRGB} = {G}_{sRGB}^{′} \div 12.92 \\ if {G}_{sRGB}^{′} > 0.04045 \\ {G}_{sRGB} = {( ( {G}_{sRGB}^{′} + 0.055 ) \div 1.055 )}^{2.4}\end{matrix} \} & ( 26 ) \\ < \#27 > & \\ \begin{matrix}if {B}_{sRGB}^{′} ≦ 0.04045 \\ {B}_{sRGB} = {B}_{sRGB}^{′} \div 12.92 \\ if {B}_{sRGB}^{′} > 0.04045 \\ {B}_{sRGB} = {( ( {B}_{sRGB}^{′} + 0.055 ) \div 1.055 )}^{2.4}\end{matrix} \} & ( 27 )\end{matrix}$$

Furthermore, like in Embodiment 2, the data sent from the electronic device 20 to the liquid crystal display device 30 may be compliant with the bg-sRGB standard. In this case, the following process is implemented.

First, in the electronic device 20, a gamma correction process is performed using equations (28) to (30).

$$\begin{matrix}< \#28 > & \\ \begin{matrix}if {R}_{sRGB} < - 0.0031308 \\ {R}_{sRGB}^{′} = - 1.055 \times {( - {R}_{sRGB} )}^{1 / 2.4} + 0.055 \\ if - 0.0031308 ≦ {R}_{sRGB} < 0.0031308 \\ {R}_{sRGB}^{′} = {R}_{sRGB} \times 12.92 \\ if {R}_{sRGB} > 0.0031308 \\ {R}_{sRGB}^{′} = 1.055 \times {R}_{sRGB}^{1 / 2.4} - 0.055\end{matrix} \} & ( 28 ) \\ < \#29 > & \\ \begin{matrix}if {G}_{sRGB} < - 0.0031308 \\ {G}_{sRGB}^{′} = - 1.055 \times {( - {G}_{sRGB} )}^{1 / 2.4} + 0.055 \\ if - 0.0031308 ≦ {G}_{sRGB} < 0.0031308 \\ {G}_{sRGB}^{′} = {G}_{sRGB} \times 12.92 \\ if {G}_{sRGB} > 0.0031308 \\ {G}_{sRGB}^{′} = 1.055 \times {G}_{sRGB}^{1 / 2.4} - 0.055\end{matrix} \} & ( 29 ) \\ < \#30 > & \\ \begin{matrix}if {B}_{sRGB} < - 0.0031308 \\ {B}_{sRGB}^{′} = - 1.055 \times {( - {B}_{sRGB} )}^{1 / 2.4} + 0.055 \\ if - 0.0031308 ≦ {B}_{sRGB} < 0.0031308 \\ {B}_{sRGB}^{′} = {B}_{sRGB} \times 12.92 \\ if {B}_{sRGB} > 0.0031308 \\ {B}_{sRGB}^{′} = 1.055 \times {B}_{sRGB}^{1 / 2.4} - 0.055\end{matrix} \} & ( 30 )\end{matrix}$$

Next, in the electronic device 20, a normalization process is performed using equation (31) to convert the gamma-corrected R′G′B′ values to integers. Note that in equation (31), int is a function that converts the quantity inside parentheses to an integer, WDC is a digital representation of the white point, and KDC is a digital representation of the black point.

$$\begin{matrix}< \#31 > & \\ \begin{matrix}{R}_{bg - sRGB} = int ( ( WDC - KDC ) \times {R}_{sRGB}^{′} + KDC ) \\ {G}_{bg - sRGB} = int ( ( WDC - KDC ) \times {G}_{sRGB}^{′} + KDC ) \\ {B}_{bg - sRGB} = int ( ( WDC - KDC ) \times {B}_{sRGB}^{′} + KDC )\end{matrix} \} & ( 31 )\end{matrix}$$

When using a 10-bit bg-sRGB color space, equation (31) can be rewritten as equation (32).

$$\begin{matrix}< \#32 > & \\ \begin{matrix}{R}_{bg - sRGB ( 10 )} = int ( 510 \times {R}_{sRGB}^{′} + 384 ) \\ {G}_{bg - sRGB ( 10 )} = int ( 510 \times {G}_{sRGB}^{′} + 384 ) \\ {B}_{bg - sRGB ( 10 )} = int ( 510 \times {B}_{sRGB}^{′} + 384 )\end{matrix} \} & ( 32 )\end{matrix}$$

Next, in the liquid crystal display device 30, equation (33) is used to convert the data sent from the electronic device 20 back to pre-normalization data. Note that equation (33) represents the inverse operation of equation (31).

$$\begin{matrix}< \#33 > & \\ \begin{matrix}{R}_{sRGB}^{′} = \frac{{R}_{bg - sRGB} - KDC}{WDC - KDC} \\ {G}_{sRGB}^{′} = \frac{{G}_{bg - sRGB} - KDC}{WDC - KDC} \\ {B}_{sRGB}^{′} = \frac{{B}_{bg - sRGB} - KDC}{WDC - KDC}\end{matrix} \} & ( 33 )\end{matrix}$$

When using a 10-bit bg-sRGB color space, equation (33) can be rewritten as equation (34).

$$\begin{matrix}< \#34 > & \\ \begin{matrix}{R}_{sRGB}^{′} = \frac{{R}_{bg - sRGB ( 10 )} - 384}{510} \\ {G}_{sRGB}^{′} = \frac{{G}_{bg - sRGB ( 10 )} - 384}{510} \\ {B}_{sRGB}^{′} = \frac{{B}_{bg - sRGB ( 10 )} - 384}{510}\end{matrix} \} & ( 34 )\end{matrix}$$

Next, in the liquid crystal display device 30, a de-gamma correction process is performed using equations (35) to (37).

$$\begin{matrix}< \#35 > & \\ \begin{matrix}if {R}_{sRGB}^{′} < - 0.04045 \\ {R}_{sRGB} = - {( ( {{R}^{′}}_{sRGB} + 0.055 ) \div 1.055 )}^{2.4} \\ if - 0.04045 ≦ {R}_{sRGB}^{′} ≦ 0.04045 \\ {R}_{sRGB} = {R}_{sRGB}^{′} \div 12.92 \\ if {R}_{sRGB}^{′} > 0.04045 \\ {R}_{sRGB} = {( ( {R}_{sRGB}^{′} + 0.055 ) \div 1.055 )}^{2.4}\end{matrix} \} & ( 35 ) \\ < \#36 > & \\ \begin{matrix}if {G}_{sRGB}^{′} < - 0.04045 \\ {G}_{sRGB} = - {( ( {G}_{sRGB}^{′} + 0.055 ) \div 1.055 )}^{2.4} \\ if - 0.04045 ≦ {G}_{sRGB}^{′} ≦ 0.04045 \\ {G}_{sRGB} = {G}_{sRGB}^{′} \div 12.92 \\ if {G}_{sRGB}^{′} > 0.04045 \\ {G}_{sRGB} = {( ( {G}_{sRGB}^{′} + 0.055 ) \div 1.055 )}^{2.4}\end{matrix} \} & ( 36 ) \\ < \#37 > & \\ \begin{matrix}if {B}_{sRGB}^{′} < - 0.04045 \\ {B}_{sRGB} = - {( ( {B}_{sRGB}^{′} + 0.055 ) \div 1.055 )}^{2.4} \\ if - 0.04045 ≦ {B}_{sRGB}^{′} ≦ 0.04045 \\ {B}_{sRGB} = {B}_{sRGB}^{′} \div 12.92 \\ if {B}_{sRGB}^{′} > 0.04045 \\ {B}_{sRGB} = {( ( {B}_{sRGB}^{′} + 0.055 ) \div 1.055 )}^{2.4}\end{matrix} \} & ( 37 )\end{matrix}$$

### 4.3 Effects

In the color reproduction system 15 of the present embodiment, gamma-corrected image data DAT is sent from the electronic device 20 to the liquid crystal display device 30. Therefore, as in Embodiment 3, even when the liquid crystal panel 320 exhibits a non-linear relationship between the gradation values in the input signal (the display data DOUT) input thereto and the resulting display brightness, the colors represented in the input data DIN input to the electronic device 20 can still be reproduced accurately on the liquid crystal panel 320. The present embodiment also achieves all of the same effects as Embodiment 1.

### 5. Embodiment 5

### 5.1 Configuration

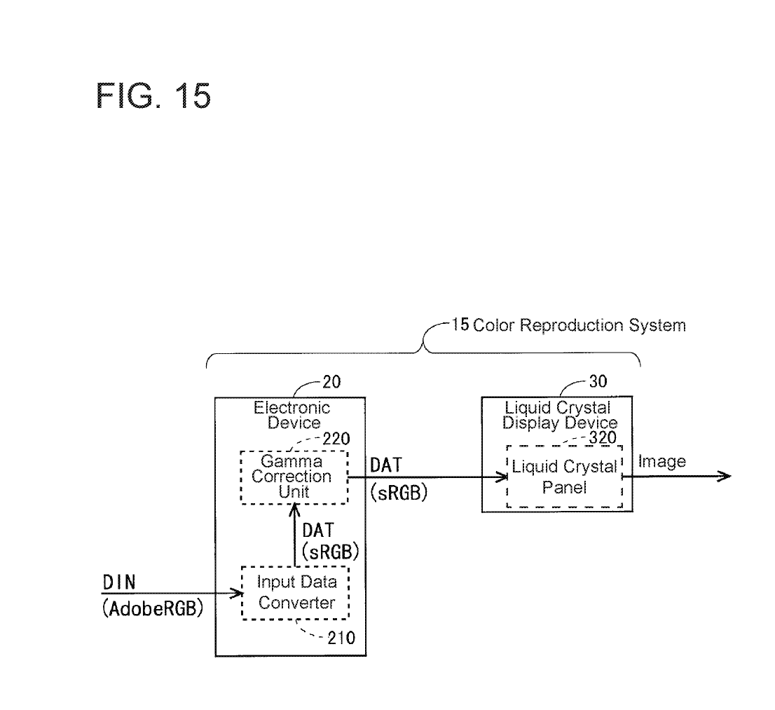

FIG. 15 is a block diagram illustrating an overall configuration of a color reproduction system 15 according to Embodiment 5 of the present invention Like in Embodiment 1, this color reproduction system 15 includes an electronic device 20 and a liquid crystal display device 30. The electronic device 20 is configured the same as in Embodiment 4 (see FIG. 12). Unlike in Embodiment 1, in the present embodiment the liquid crystal display device 30 does not include an image data converter 310. In other words, in the present embodiment the liquid crystal display device 30 is a general-purpose display.

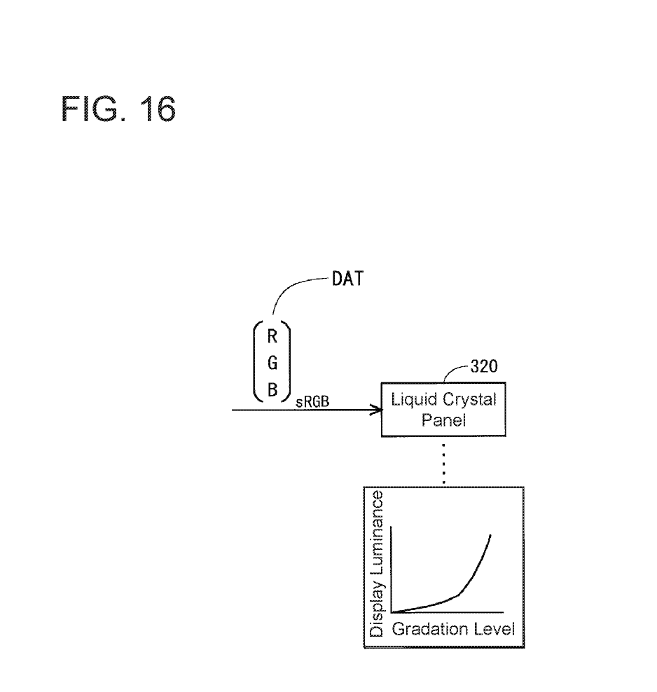

As in Embodiment 4, in the present embodiment a gamma correction process is performed on image data DAT generated by the input data converter 210, and then the gamma-corrected image data DAT is sent to the liquid crystal display device 30. As illustrated in FIG. 16, the liquid crystal display device 30 does not implement a color gamut conversion process, and the image data DAT sent from the electronic device 20 is input as-is to the liquid crystal panel 320. In other words, sRGB data is input to the liquid crystal panel 320. Furthermore, like in Embodiment 2, the image data DAT sent from the electronic device 20 to the liquid crystal display device 30 may be compliant with the bg-sRGB standard.

Typically, the gamma characteristics of general-purpose displays are designed such that γ=2.2. Therefore, the gamma correction processor 220 of the electronic device 20 implements a gamma correction process with γ=2.2. Doing this ensures compatibility of gamma characteristics between the electronic device 20 and the liquid crystal display device 30.

Moreover, general-purpose displays can only handle RGB values that are greater than or equal to 0 and less than or equal to 1. As a result, if image data DAT that includes RGB values that are negative or greater than 1 is input to the liquid crystal panel 320, the liquid crystal panel 320 will not be able to accurately reproduce the colors represented in the original input data DIN. Therefore, the configuration of the present embodiment may be applied to a system that does not strictly require accurate color reproduction.

### 5.2 Effects

In the present embodiment, gamma-corrected sRGB image data DAT is sent from the electronic device 20 to the liquid crystal display device 30, and in the liquid crystal display device 30, the sRGB image data DAT sent from the electronic device 20 is input as-is to the liquid crystal panel 320. Therefore, the present embodiment makes it possible to use a relatively simple configuration to prevent differences in display image coloring due to the primary device (the electronic device 20) in cases in which a general-purpose display with a standard color gamut is used.

### 6. Other

The present invention is not limited to the embodiments described above, and various modifications may be made without departing from the spirit of the present invention. For example, in the embodiments described above, the data sent from the electronic device 20 to the liquid crystal display device 30 was sRGB data or bg-sRGB data. However, the present invention is not limited to these examples. The data sent from the electronic device 20 to the liquid crystal display device 30 may be compliant with any standard including standards other than sRGB and bg-sRGB as long as the standard is defined in advance.

### DESCRIPTION OF REFERENCE CHARACTERS

11-15 color reproduction system
20 electronic device
30 liquid crystal display device
210 input data converter
220 gamma correction processor (image data gamma correction processor)
310 image data converter
320 liquid crystal panel
330 gamma correction processor (display data gamma correction processor)
340 de-gamma correction processor
400 color gamut converter
DIN input data
DAT image data
DOUT display data

1: A color reproduction system, comprising:
a processing unit that performs a color gamut conversion process on input data so as to output image data; and a liquid crystal display device having a liquid crystal panel, the liquid crystal display device displaying on the liquid crystal panel a color image based on the image data output from the processing unit,
wherein a color gamut of the liquid crystal panel includes a color gamut specified by a prescribed standard, and
wherein, when the input data is not expressed in terms of the prescribed standard, the processing unit performs the color gamut conversion process on the input data so as to output image data that is expressed in terms of the prescribed standard so that the processing unit sends to the liquid crystal display device as the image data only an RGB signal expressed in terms of said prescribed standard.

2: The color reproduction system according to claim 1, wherein the prescribed standard is an sRGB standard.

3: The color reproduction system according to claim 1, wherein the prescribed standard is a bg-sRGB standard.

4: The color reproduction system according to claim 3, wherein the processing unit is configured to receive the input data, a color gamut of the input data being within the color gamut of the liquid crystal panel.

5: The color reproduction system according to claim 3, wherein when a minimum gradation value is 0 and a maximum gradation value is 1, the RGB signal sent from the processing unit to the liquid crystal display device can include values that are negative or greater than 1.

6: The color reproduction system according to claim 3, wherein the image data sent from the processing unit to the liquid crystal display device is 10-bit data.

7: The color reproduction system according to claim 1,
wherein the processing unit includes an input data converter that generates the image data by performing, in accordance with a color gamut of the input data and the color gamut specified by the prescribed standard, a color gamut conversion process on the input data, and
wherein the liquid crystal display device includes an image data converter that generates display data for the liquid crystal panel by performing, in accordance with the color gamut specified by the prescribed standard and the color gamut of the liquid crystal panel, a color gamut conversion process on the image data sent from the processing unit.

8: The color reproduction system according to claim 1,
wherein the processing unit includes an input data converter that generates the image data by performing, in accordance with a color gamut of the input data and the color gamut specified by the prescribed standard, a color gamut conversion process on the input data, and
wherein the liquid crystal display device includes:
an image data converter that generates display data for the liquid crystal panel by performing, in accordance with the color gamut specified by the prescribed standard and the color gamut of the liquid crystal panel, a color gamut conversion process on the image data sent from the processing unit; and
a display data gamma correction processor that performs a gamma correction process on the display data generated by the image data converter.

9: The color reproduction system according to claim 1,
wherein the processing unit includes:
an input data converter that generates the image data by performing, in accordance with a color gamut of the input data and the color gamut specified by the prescribed standard, a color gamut conversion process on the input data; and
an image data gamma correction processor that performs a gamma correction process on the image data generated by the input data converter, and
wherein the liquid crystal display device includes:
a de-gamma correction processor that performs a de-gamma correction process on the image data sent from the processing unit;
an image data converter that generates display data for the liquid crystal panel by performing, in accordance with the color gamut specified by the prescribed standard and the color gamut of the liquid crystal panel, a color gamut conversion process on the image data on which the de-gamma correction processor performed the de-gamma correction process; and
a display data gamma correction processor that performs a gamma correction process on the display data generated by the image data converter.

10: The color reproduction system according to claim 1,
wherein the processing unit includes:
an input data converter that generates the image data by performing, in accordance with a color gamut of the input data and the color gamut specified by the prescribed standard, a color gamut conversion process on the input data; and
an image data gamma correction processor that performs a gamma correction process on the image data generated by the input data converter,
wherein the color gamut of the liquid crystal panel matches the color gamut specified by the prescribed standard, and
wherein the liquid crystal display device displays on the liquid crystal panel a color image based on the image data sent from the processing unit without first performing a color gamut conversion process thereon.

11: The color reproduction system according to claim 1, wherein the processing unit is configured to receive the input data, a color gamut of the input data being within the color gamut of the liquid crystal panel.

12: A color reproduction method for a color reproduction system that includes a processing unit that outputs image data in accordance with input data and a liquid crystal display device that includes a liquid crystal panel that has a color gamut including a color gamut specified by a prescribed standard and that displays a color image based on the image data output from the processing unit, the color reproduction method comprising:
a generating step in which the image data is generated by performing a color gamut conversion process on the input data by the primary device; and
a sending step in which the image data is sent from the processing unit to the liquid crystal display device,
wherein, in the generating step, when the input data is not expressed in terms of the prescribed standard, the processing unit performs the color gamut conversion process on the input data so as to output image data that is expressed in terms of the prescribed standard so that only an RGB signal expressed in terms of the prescribed standard is sent from the processing unit to the liquid crystal display device as the image data.

13: A color reproduction system, comprising:
a processing unit that outputs image data obtained by performing a color gamut conversion process on input data; and a liquid crystal display device having a liquid crystal panel, the liquid crystal display device displaying on the liquid crystal panel a color image based on the image data output from the processing unit,
wherein a plurality of operation modes are prepared so as to be selectable,
wherein a color gamut of the liquid crystal panel includes a color gamut specified by a prescribed standard, and
wherein, when a prescribed operation mode among the plurality of operation modes is selected, and when the input data is not expressed in terms of the prescribed standard, the processing unit performs the color gamut conversion process on the input data so as to output image data that is expressed in terms of the prescribed standard so that the processing unit sends to the liquid crystal display device as the image data only an RGB signal expressed in terms of the prescribed standard.

14: A color reproduction method for a color reproduction system that includes a processing unit that outputs image data in accordance with input data and a liquid crystal display device that includes a liquid crystal panel that has a color gamut including a color gamut specified by a prescribed standard and that displays a color image based on the image data output from the processing unit, the color reproduction method comprising:
a generating step in which the image data is generated by performing a color gamut conversion process on the input data by the primary device; and
a sending step in which the image data is sent from the processing unit to the liquid crystal display device,
wherein a plurality of operation modes are prepared so as to be selectable, and
wherein, when a prescribed operation mode among the plurality of operation modes is selected, in the generating step, when the input data is not expressed in terms of the prescribed standard, the processing unit performs the color gamut conversion process on the input data so as to output image data that is expressed in terms of the prescribed standard so that only an RGB signal expressed in terms of the prescribed standard is sent from the processing unit to the liquid crystal display device as the image data.
